(19) United States
(12) Patent Application Publication
(10) Pub. No.: US 2023/0317946 A1
(43) Pub. Date: Oct. 5, 2023

(54) FLUORIDE ION SECONDARY BATTERY

(71) Applicant: HONDA MOTOR CO., LTD., Tokyo (JP)

(72) Inventor: Kazuyuki SATO, Saitama (JP)

(21) Appl. No.: 18/191,891

(22) Filed: Mar. 29, 2023

(30) Foreign Application Priority Data
Mar. 29, 2022 (JP) 2022-053183
Mar. 24, 2023 (JP) 2023-048065

(51) Int. Cl. H01M 4/58; H01M 4/36; H01M 10/36

(52) U.S. Cl. CPC H01M 4/582; H01M 4/364; H01M 10/36; H01M 2004/028

(57) ABSTRACT

To provide a fluoride ion secondary battery comprising a positive electrode comprising a positive electrode active material, the positive electrode active material comprising a composite fluoride in which copper and bismuth fluoride are composited, a final discharging voltage being 0.3 V (vs. Pb/PbF₂) or less. The content of bismuth in the composite fluoride may be 20% by mass or more.

This application is based on and claims the benefit of priority from Japanese Patent Application Nos. 2022-053183 and 2023-048065, respectively filed on 29 Mar. 2022 and 24 Mar. 2023, the contents of which are incorporated herein by reference.

### BACKGROUND OF THE INVENTION

### Field of the Invention

The present invention relates to a fluoride ion secondary battery.

### Related Art

In recent years, research and development have been carried out on secondary batteries which contribute to energy efficiency in order to ensure that many people have access to affordable, reliable, sustainable and advanced energy.

There has been known, as a solid battery in which a solid electrolyte layer is disposed between a positive electrode and a negative electrode, a fluoride ion secondary battery. There has been known, as a positive electrode active material of the fluoride ion secondary battery, a composite fluoride in which metal and a fluoride having fluoride ion conductivity form a composite (see, for example, Patent Document 1).

Patent Document 1: PCT International Publication No. WO2019/187942

### SUMMARY OF THE INVENTION

However, it is desired to improve the initial charging/discharging capacity and initial charging/discharging efficiency of a fluoride ion secondary battery.

It is an object of the present invention to provide a fluoride ion secondary battery capable of improving the initial charging/discharging capacity and initial charging/discharging efficiency.

In accordance with one aspect of the present invention, there is provided a fluoride ion secondary battery including a positive electrode containing a positive electrode active material, the positive electrode active material including a composite fluoride in which copper and bismuth fluoride are composited, a final discharging voltage being 0.3 V (vs. Pb/PbF₂) or less.

The content of bismuth in the composite fluoride may be 20% by mass or more.

The positive electrode may further contain a solid electrolyte including fluorine.

The solid electrolyte may be a metal fluoride containing cerium and strontium.

The solid electrolyte may have a primary particle size of 10 nm or more and 200 nm or less.

The positive electrode further includes a second positive electrode active material, the second positive electrode material being a compound represented by a general formula

KₓBi₁₋ₓF₃₋₂ₓ

wherein x is 0.02 or more and 0.12 or less, and having a hexagonal structure.

According to the present invention, it is possible to provide a fluoride ion secondary battery capable of improving the initial charging/discharging capacity and initial charging/discharging efficiency.

### BRIEF DESCRIPTION OF THE DRAWINGS

FIG. 1 is an XRD spectrum of a composite fluoride of Example 1; and

FIG. 2 is a graph showing a charge/discharge curve in the 1st cycle of fluoride ion secondary battery cells of Example 1 and Comparative Example 1.

### DETAILED DESCRIPTION OF THE INVENTION

Hereinafter, embodiments of the present invention will be described.

### Fluoride Ion Secondary Battery

The fluoride ion secondary battery of the present embodiment includes a positive electrode containing a positive electrode active material and, for example, a solid electrolyte layer is sandwiched between the positive electrode and the negative electrode of the present embodiment. The positive electrode active material contains a composite fluoride in which copper and bismuth fluoride are composited.

The final discharging voltage of the fluoride ion secondary battery of the present embodiment is 0.3 V (vs. Pb/PbF₂) or less and is preferably 0.0V (vs. Pb/PbF₂) or less. If the final discharging voltage of the fluoride ion secondary battery exceeds 0.3 V (vs. Pb/PbF₂), the initial charging/discharging capacity and initial charging/discharging efficiency deteriorate. The final discharging voltage of the fluoride ion secondary battery of the present embodiment is not particularly limited and is, for example, −0.5 V (vs. Pb/PbF₂) or more.

The final discharging voltage of the fluoride ion secondary battery of the present embodiment is not particularly limited and is, for example, 1.3 V (vs. Pb/PbF₂) or more and 2.0 V (vs. Pb/PbF₂) or less.

The content of bismuth in the composite fluoride is preferably 20% by mass or more, and more preferably 30% by mass or more. If the content of bismuth in the composite fluoride is 20% by mass or more, the capacity retention rate of the fluoride ion secondary battery of the present embodiment is improved. The content of bismuth in the composite fluoride is not particularly limited and is, for example, 70% by mass or less.

The average particle size of the composite fluoride is preferably 35 nm or less, and more preferably 25 nm or less. If the average particle size of the composite fluoride is 35 nm or less, the effective area contributing to an electrode reaction of the composite fluoride increases. As a result, temperature characteristics of the charging/discharging capacity of the fluoride ion secondary battery of the present embodiment are improved, and the battery can sufficiently operate even in a low-temperature environment. The average particle size of the composite fluoride is not particularly limited and is, for example, 20 nm or more.

Here, the average particle size means a particle size of primary particles calculated from a specific surface area by a constant capacity type gas adsorption method.

The positive electrode active material of the present embodiment can be produced by an aerosol process. For example, copper and bismuth fluoride are melted and then sprayed under reduced pressure.

### (Positive Electrode)

As mentioned above, the positive electrode contains a positive electrode active material and, for example, a positive electrode mixture layer is formed on a positive electrode current collector. At this time, the positive electrode mixture layer may contain a composite fluoride, and may further contain a positive electrode active material other than the composite fluoride, a solid electrolyte containing fluorine, a conductive aid and the like as necessary. If the positive electrode further contains a solid electrolyte containing fluorine, bismuth fluoride will be effectively used, because when the bismuth fluoride is defluorinated during discharging of the fluoride ion second battery, the solid electrolyte that contains fluorine exists. Due to this, the initial discharging capacity of the fluoride ion secondary battery is improved.

The positive electrode current collector is not particularly limited as long as it has electronic conductivity, and examples thereof include a gold foil and the like. The solid electrolyte is not particularly limited as long as it is a metal fluoride that has fluoride ion conductivity and is not defluorinated during discharging of the fluoride ion secondary battery. Examples thereof include PbSnF₄, Ce_{0.975}Sr_{0.025}F_{2.975}, La_{0.93}Ba_{0.07}F_{2.93}, Ca_{0.5}Sr_{0.5}F₂, Sr_{0.7}Y_{0.3}F_{2.3,} Ba_{0.7}Sb_{0.3}F_{2.3}, La_{0.9}Sr_{0.1}F_{2.9}, Ba_{0.5}Ca_{0.5}F₂, and the like. Among these, a metal fluoride containing cerium and strontium is preferred. The conductive aid is not particularly limited as long as it has electronic conductivity, and examples thereof include acetylene black and the like.

The solid electrolyte has a primary particle size of preferably 10 nm or more and 200 nm or less, and more preferably 10 nm or more and 100 nm or less. If the solid electrolyte has a primary particle size of 10 nm or more and 200 nm or less, the initial discharging capacity of the fluoride ion secondary battery is improved.

The positive electrode further includes a second positive electrode active material, and the second positive electrode material is preferably a compound represented by a general formula

KₓBi₁₋ₓF₃₋₂ₓ

wherein x is 0.02 or more and 0.12 or less, and having a hexagonal structure. The second positive electrode active material has higher fluoride ion conductivity than bismuth fluoride, and therefore the initial discharging capacity of the fluoride ion secondary battery is improved.

The positive electrode may have a porous structure. Thereby, the electrochemical reaction efficiency of the fluoride ion secondary battery of the present embodiment is improved.

The positive electrode of the present embodiment is obtained, for example, by molding a powder composition containing a positive electrode active material, a solid electrolyte and a conductive aid of the present embodiment.

### (Negative Electrode)

Regarding the negative electrode, for example, a negative electrode mixture layer is formed on a negative electrode current collector. At this time, the negative electrode mixture layer may contain a negative electrode active material, and may further contain a solid electrolyte, a conductive aid and the like as necessary.

The negative electrode current collector is not particularly limited as long as it has electronic conductivity, and examples thereof include a gold foil and the like. Examples of the negative electrode active material include, but are not particularly limited to, lead and the like. The solid electrolyte is not particularly limited as long as it has fluoride ion conductivity, and examples thereof include PbSnF₄ and the like. The conductive aid is not particularly limited as long as it has electronic conductivity, and examples thereof include acetylene black and the like.

It is possible to use, as the negative electrode, a lead foil serving as a negative electrode current collector and a negative electrode active material.

The solid electrolyte constituting the solid electrolyte layer is not particularly limited as long as it has fluoride ion conductivity, and examples thereof include PbSnF₄ and the like.

The fluoride ion secondary battery of the present embodiment can be obtained, for example, by sequentially stacking a material constituting a positive electrode (for example, a positive electrode current collector and a powder composition for positive electrode mixture layer), a material constituting a solid electrolyte, and a material constituting a negative electrode (for example, a negative electrode current collector and a powder composition for negative electrode mixture layer), followed by integral molding.

While embodiments of the present invention have been described, the present invention is not limited to the above embodiments and the above embodiments may be appropriately varied within the spirit of the present invention.

### EXAMPLES

Examples of the present invention will be described below, but the present invention is not limited to the following Examples.

### Example 1

After weighing copper having an average particle size of 1 μm (manufactured by Kojundo Chemical Lab. Co., Ltd.) and bismuth fluoride (manufactured by Kojundo Chemical Lab. Co., Ltd.) at a mass ratio of 61:39, they were premixed for about 1 hour using a mortar and a pestle made of agate to obtain a raw material mixed powder.

The raw materials were weighed and premixed in a purge-type (DBO-type) glove box (manufactured by Miwa Mfg Co., Ltd.) in order to prevent moisture absorption of a fluoride and oxidation of copper.

Using a stainless steel mesh having a mesh size of 500 μm, the raw material mixed powder thus obtained was subjected to a classification treatment. Next, operation of mixing raw material mixed powder which did not pass through the mesh, with the mortar and pestle made of agate and then subjecting the raw material mixed powder to the classification treatment was carried out until the entire raw material mixed powder passed through the mesh.

A closed type powder hopper enclosing the raw material mixed powder after subjecting to the classification treatment was taken out from a glove box, and was connected to an induction thermal plasma nanoparticle synthesis system TP-40020NPS (manufactured by JEOL Ltd.). After supplying argon gas to a plasma torch, the raw material mixed powder was melted by thermal plasma to give a raw material melt, and the raw material melt was sprayed into a chamber in a vacuum environment. The raw material melt sprayed into the chamber was granulated into nanoparticles by passing through a cooling step, thus obtaining a composite fluoride (Cu-BiF₃). Subsequently, the composite fluoride was collected by an exhaust filter and, after shutting out upstream and downstream of the exhaust filter by a valve, the composite fluoride was transported into a glove box, thus recovering the composite fluoride.

### Example 2

In the same manner as in Example 1, except for weighing copper having an average particle size of 1 μm (manufactured by Kojundo Chemical Lab. Co., Ltd.) and bismuth fluoride (manufactured by Kojundo Chemical Lab. Co., Ltd.) at a mass ratio of 71:29, a composite fluoride was obtained.

### Comparative Example 1

In the same manner as in Example 1, except for weighing copper having an average particle size of 1 μm (manufactured by Kojundo Chemical Lab. Co., Ltd.) and barium fluoride (manufactured by Kojundo Chemical Lab. Co., Ltd.) at a mass ratio of 90:10, a composite fluoride (Cu-BaF₂) was obtained.

### Crystal Structure

Using an automated multipurpose X-ray diffractometer SmartLaB (manufactured by Rigaku Corporation, Cu-Kα source, λ=1.5418Å), the crystal structure of the composite fluoride of Example 1 was analyzed.

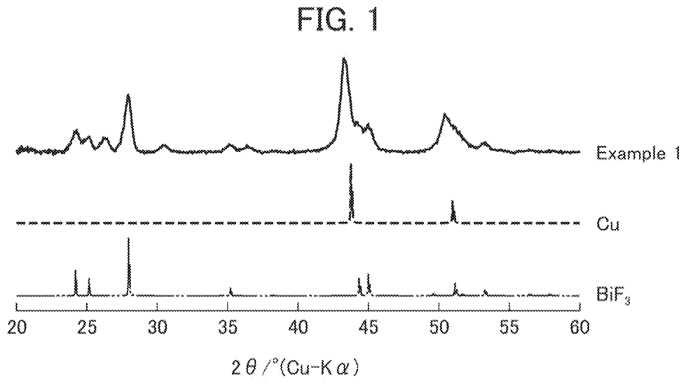

FIG. 1 shows an XRD spectrum of the composite fluoride of Example 1. FIG. 1 also shows XRD spectra of Cu and BiF₃.

As is apparent from FIG. 1, the crystal structure of the composite fluoride of Example 1 is a crystal structure in which a crystal structure of Cu and a crystal structure of BiF₃ are composited.

### Fabrication of Fluoride Ion Secondary Battery 1

Using the composite fluorides of Examples 1 and 2 and Comparative Example 1, fluoride ion secondary batteries were fabricated.

### (Solid Electrolyte)

As the solid electrolyte, PbSnF₄ was used.

### (Positive Electrode Current Collector)

As the positive electrode current collector, a gold foil was used.

### (Powder Composition for Positive Electrode Mixture Layer)

After weighing a composite fluoride as the positive electrode active material, PbSnF₄ as the solid electrolyte and acetylene black (manufactured by Denki Kagaku Kogyo Kabushiki Kaisha) as the conductive aid at a mass ratio of 30:65:5, they were sufficiently mixed to obtain a powder composition for positive electrode mixture layer.

### (Negative Electrode)

A lead foil having a thickness of 200 μm (manufactured by The Nilaco Corporation) serving as the negative electrode current collector and a negative electrode active material was formed into a negative electrode having a diameter of 10 mm.

### (Cell)

In a mold having a diameter of 10 mm, a positive electrode current collector, a powder composition for positive electrode mixture layer (20 mg), a solid electrolyte (400 mg) and a negative electrode were sequentially stacked and then integrally molded under the pressure of 4 t/cm² to obtain a fluoride ion secondary battery cell. At this time, a gold wire as a terminal used for charge/discharge measurement was bonded to surfaces of a positive electrode current collector and a negative electrode of the cell using a carbon paste.

### Charging/Discharging Capacity

A current-constant charging/discharging test of the fluoride ion secondary battery cell was carried out at 140° C. Specifically, using a potentio-galvanostat SI1287/1255B (manufactured by Solartron), a current-constant charging/discharging test was carried out under the conditions of a current during charging/discharging of 40 μA, a final discharging voltage of 1.3 V (vs. Pb/PbF₂) and a final discharging voltage of −0.5 V. At this time, in order to control the temperature of the cell during charging/discharging, the cells were placed in a portable environmental tester SU261 (manufactured by ESPEC Corporation) and a current-constant charging/discharging test was carried out.

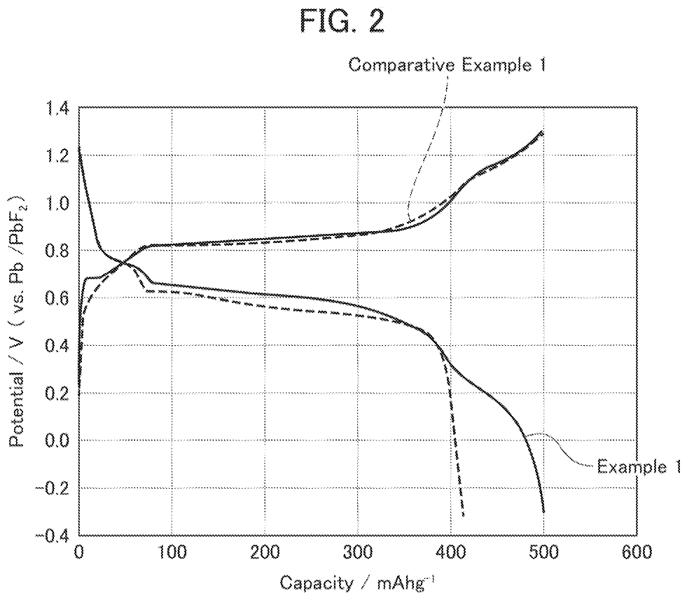

FIG. 2 shows a charge/discharge curve in the 1st cycle of fluoride ion secondary battery cells of Example 1 and Comparative Example 1. Note that the capacity on the horizontal axis of FIG. 2 is a capacity per 1 g of the composite fluoride.

As is apparent from FIG. 2, the fluoride ion secondary battery cell of Example 1 exhibits higher initial charging/discharging capacity than that of the fluoride ion secondary battery cell of Comparative Example 1. The reason is presumed that the fluoride ion conductivity of the positive electrode active material of Example 1 is higher than the fluoride ion conductivity of the positive electrode active material of Comparative Example 1.

### Initial Charging/Discharging Efficiency

A ratio of the initial discharging capacity to the initial charging capacity was determined and defined as the initial charging/discharging efficiency.

### Capacity Retention Rate

A ratio of the charging capacity in the 5th cycle to the initial charging capacity was determined and defined as the capacity retention rate.

Table 1 shows the evaluation results of the initial charging/discharging efficiency and the capacity retention rate of the fluoride ion secondary battery cell.

TABLE 1

| | | | | Initial | |
|---|---|---|---|---|---|
| | | Initial | Initial | charging/ | Capacity |
| | Content of Bi in | charging | discharging | discharging | retention |
| | composite fluoride | capacity | capacity | efficiency | rate |
| | [% by mass] | [mAhg⁻¹] | [mAhg⁻¹] | [%] | [%] |
| Example 1 | 31 | 520 | 524 | 100.3 | 80 |
| Example 2 | 23 | 570 | 578 | 101.4 | 60 |
| Comparative | — | 500 | 410 | 81.9 | 65 |
| Example 1 | | | | | |

As is apparent from Table 1, the fluoride ion secondary batteries of Examples 1 and 2 exhibit higher initial charging/discharging capacity and initial charging/discharging efficiency than those of fluoride ion secondary battery of Comparative Example 1.

### Fabrication of Fluoride Ion Secondary Battery 2

Using the composite fluoride of Example 1, a fluoride ion secondary battery was fabricated.

(Fabrication of Ce_{0.92}Sr_{0.08}F_{2.92})

After weighing cerium fluoride (manufactured by Kojundo Chemical Lab. Co., Ltd.) and strontium fluoride (manufactured by Kojundo Chemical Lab. Co., Ltd.), they were premixed for about 1 hour using a mortar and pestle made of agate to obtain a raw material mixed powder.

Using a stainless steel mesh having a mesh size of 500 μm, the raw material mixed powder thus obtained was subjected to a classification treatment. Next, operation of mixing raw material mixed powder which did not pass through the mesh with the mortar and pestle made of agate and then subjecting the obtained raw material mixed powder to a classification treatment was carried out until the entire raw material mixed powder passed through the mesh.

The raw materials were weighed, premixed, and classified in a purge-type (DBO-type) glove box (manufactured by Miwa Mfg Co., Ltd.) in order to prevent moisture absorption of the fluoride.

A closed type powder hopper enclosing the raw material mixed powder after subjecting to the classification treatment was taken out from the glove box, and was connected to an induction thermal plasma nanoparticle synthesis system TP-40020NPS (manufactured by JEOL Ltd.). After supplying argon gas to a plasma torch, the raw material mixed powder was melted by thermal plasma to give a raw material melt, and the raw material melt was sprayed into a chamber in a vacuum environment. The raw material melt sprayed into the chamber was granulated into nanoparticles by passing through a cooling step, thus obtaining Ce_{0.92}Sr_{0.08}F_{2.92}. Subsequently, the Ce_{0.92}Sr_{0.08}F_{2.92} was collected by an exhaust filter and, after shutting out upstream and downstream of the exhaust filter by a valve, the Ce_{0.92}Sr_{0.08}F_{2.92} was transported into the glove box, thus recovering the Ce_{0.92}Sr_{0.08}F_{2.92}. Here, the composition of the Ce_{0.92}Sr_{0.08}F_{2.92}was analyzed using ICP emission spectroscopy.

### (Powder Composition for Positive Electrode Mixture Layer)

After weighing a composite fluoride as the positive electrode active material, Ce_{0.92}Sr_{0.08}F_{2.92} as the solid electrolyte and acetylene black (manufactured by Denki Kagaku Kogyo Kabushiki Kaisha) as the conductive aid at a mass ratio of 30:65:5, they were sufficiently mixed to obtain a powder composition for positive electrode mixture layer.

Fluoride ion secondary battery 2 was fabricated in the same manner as the fluoride ion secondary battery 1, except that the obtained powder composition for positive electrode mixture layer was used.

Evaluating the initial charging/discharging efficiency and the capacity retention rate of the fluoride ion secondary battery 2 in the same manner as the fluoride ion secondary battery 1, the initial charging capacity was 528 mAhg⁻¹, the initial discharging capacity was 532 mAhg⁻¹, the initial charging/discharging efficiency was 100.8%, and the capacity retention rate was 80.2%.

### Fabrication of Fluoride Ion Secondary Battery 3

Using the composite fluoride of Example 1, a fluoride ion secondary battery was fabricated.

### Fabrication of K_{0.06}Bi_{0.94}F_{2.88}

After weighing potassium fluoride (manufactured by Kojundo Chemical Lab. Co., Ltd.) and bismuth fluoride (manufactured by Kojundo Chemical Lab. Co., Ltd.), they were premixed for about 1 hour using a mortar and pestle made of agate to obtain a raw material mixed powder.

Using a stainless steel mesh having a mesh size of 500 μm, the raw material mixed powder thus obtained was subjected to a classification treatment. Next, operation of mixing raw material mixed powder which did not pass through the mesh with the mortar and pestle made of agate and then subjecting the obtained raw material mixed powder to the classification treatment was carried out until the entire raw material mixed powder passed through the mesh.

The raw materials were weighed, premixed, and classified in a purge-type (DBO-type) glove box (manufactured by Miwa Mfg Co., Ltd.) in order to prevent moisture absorption of the fluoride.

A closed type powder hopper enclosing the raw material mixed powder after subjecting to the classification treatment was taken out from the glove box, and was connected to an induction thermal plasma nanoparticle synthesis system TP-40020NPS (manufactured by JEOL Ltd.). After supplying argon gas to a plasma torch, the raw material mixed powder was melted by thermal plasma to give a raw material melt, and the raw material melt was sprayed into a chamber in a vacuum environment. The raw material melt sprayed into the chamber was granulated into nanoparticles by passing through a cooling step, thus obtaining K_{0.06}Bi_{0.94}F_{2.88}. Subsequently, the K_{0.06}Bi_{0.94}F_{2.88} was collected by an exhaust filter and, after shutting out upstream and downstream of the exhaust filter by a valve, the K_{0.06}Bi_{0.94}F_{2.88} was transported into the glove box, thus recovering the K_{0.06}Bi_{0.94}F_{2.88}. Here, the composition of the K_{0.06}Bi_{0.94}F_{2.88} was analyzed using ICP emission spectroscopy.

### (Powder Composition for Positive Electrode Mixture Layer)

After weighing a composite fluoride as the positive electrode active material, K_{0.06}Bi_{0.94}F_{2.88} as the positive electrode active material, Ce_{0.92}Sr_{0.08}F_{2.92} as the solid electrolyte and acetylene black (manufactured by Denki Kagaku Kogyo Kabushiki Kaisha) as the conductive aid at a mass ratio of 30:10:55:5, they were sufficiently mixed to obtain a powder composition for positive electrode mixture layer.

Fluoride ion secondary battery 3 was fabricated in the same manner as the fluoride ion secondary battery 1, except that the obtained powder composition for positive electrode mixture layer was used.

Evaluating the initial charging/discharging efficiency and the capacity retention rate of the fluoride ion secondary battery 3 in the same manner as the fluoride ion secondary battery 1, the initial charging capacity was 529 mAhg⁻¹, the initial discharging capacity was 544 mAhg⁻¹, the initial charging/discharging efficiency was 102.8%, and the capacity retention rate was 81%. Compared to the fluoride ion secondary battery, it can be seen that K_{0.06}Bi_{0.94}F_{2.88} contributes as the discharging capacity.

What is claimed is:

1. A fluoride ion secondary battery comprising a positive electrode comprising positive electrode active material,
the positive electrode active material comprising a composite fluoride in which copper and bismuth fluoride are composited,
a final discharging voltage being 0.3 V (vs. Pb/PbF₂) or less.

2. The fluoride ion secondary battery according to claim 1, wherein the content of bismuth in the composite fluoride is 20% by mass or more.

3. The fluoride ion secondary battery according to claim 1, wherein the positive electrode further comprises a solid electrolyte comprising fluorine.

4. The fluoride ion secondary battery according to claim 3, wherein the solid electrolyte is a metal fluoride containing cerium and strontium.

5. The fluoride ion secondary battery according to claim 3, wherein the solid electrolyte has a primary particle size of 10 nm or more and 200 nm or less.

6. The fluoride ion secondary battery according to claim 1, wherein the positive electrode further comprises a second positive electrode active material, and
the second positive electrode material is a compound represented by a general formula
KₓBi₁₋ₓF₃₋₂ₓ
wherein x is 0.02 or more and 0.12 or less, and
having a hexagonal structure.
